(19) United States
(12) Patent Application Publication
(10) Pub. No.: US 2023/0331193 A1
(43) Pub. Date: Oct. 19, 2023

(54) DEVICE FOR CLEANING A DETECTION SYSTEM

(71) Applicant: VALEO SYSTEMES D'ESSUYAGE, La Verriere (FR)

(72) Inventor: Maxime BAUDOUIN, La Verriere (FR)

(73) Assignee: VALEO SYSTEMES D'ESSUYAGE, La Verriere (FR)

(21) Appl. No.: 18/006,210

(22) PCT Filed: Jul. 6, 2021
(86) PCT No.: PCT/EP2021/068603

§ 371 Date: Jan. 20, 2023

(30) Foreign Application Priority Data
Jul. 22, 2020 (FR) 2007686

(51) Int. Cl. B60S 1/56; H04N 23/81; B60S 1/54; G02B 27/00

(52) U.S. Cl. CPC B60S 1/56; H04N 23/811; B60S 1/54; G02B 27/0006; G01S 2007/4977

(57) ABSTRACT

The invention relates to a method for cleaning a detection system provided in a motor vehicle, the detection system including a glazed surface, at least one detection device and a device for acquiring information from the detection device, which acquires the information at a first frequency, the vehicle includes a cleaning device with pulsed air directed onto the glazed surface which projects the pulsed air onto the glazed surface of the detection system at a second frequency, the first frequency and the second frequency being substantially identical.

### TECHNICAL FIELD

The present invention relates to the field of motor-vehicle cleaning systems. More particularly, the invention relates to systems for cleaning detecting systems installed in motor vehicles.

### BACKGROUND OF THE INVENTION

When the detecting systems, for example optical or electromagnetic sensors, are placed behind a windshield of a motor vehicle, these detecting systems are cleaned indirectly by the wiping movement of a windshield-wiping system, especially on appearance of meteorological phenomena. In order to ensure data are read by the detecting system reliably, the latter is then configured to be synchronized with the movement of the wiping system when the latter passes in front of the detecting system.

When detecting systems are not positioned behind the windshield of the motor vehicle, they may have a glazed area distinct from said windshield and which may be subject to external dirtying. These detecting systems are then associated with a cleaning device that is independent of and distinct from the windshield-wiping system.

One of the problems with the cleaning devices of these detecting systems resides in the fact that, on the one hand, they must be synchronized with the capture of data by the detecting system, and on the other hand they may require a new control unit to be created to allow this synchronization between the detecting system and the cleaning device. In other words, detecting systems, when they are configured to operate behind the motor-vehicle windshield comprising the wiping system, see their performance and the reliability with which they capture data decreased when they are not similarly synchronized with the cleaning device.

### SUMMARY OF THE INVENTION

One aim of the present invention is therefore to remedy the aforementioned drawbacks by providing a device for cleaning a detecting system that is configured to be synchronized with the capture of data by the detecting system. Optionally, this detecting system may also be synchronized with the system for wiping the windshield of the motor vehicle.

The invention therefore relates to a method for cleaning a detecting system with which a vehicle is equipped, the detecting system comprising a glazed area, at least one detecting device and a device for acquiring information from the detecting device, the vehicle comprising a cleaning device employing pulsed air directed onto the glazed area, the acquiring device capturing information from the detecting device at a given first frequency and the cleaning device blowing the pulsed air onto the glazed area at a second frequency identical to the first frequency, plus or minus 10%.

Such a detecting-system cleaning method allows computing means previously developed by a car manufacturer to be employed and thus avoids the need for new upstream development. In other words, by virtue of the cleaning method of the invention, detecting systems that, in the prior art, were placed behind a windshield of a motor vehicle and were therefore configured to operate in synchronization with a system for wiping said windshield, are able to operate reliably when they are not placed behind the windshield, without requiring new development beforehand.

The vehicle is for example a motor vehicle comprising at least the windshield and the wiping system capable of wiping the surface of the windshield. According to a first example of the invention, the glazed area of the detecting system may be distinct from the windshield of the motor vehicle. According to a second example of the invention, the glazed area may also be a segment of the windshield of the motor vehicle the surface of which is not wiped by the wiper blades.

The glazed area is placed facing the detecting device, so that the latter may be protected while capturing information on the environment outside the motor vehicle. It will thus be understood that the glazed area is a transparent or translucent area, so as to allow rays emitted and/or received by the detecting device to pass. The glazed area may for example be, non-limitingly, glass or Plexiglas.

The detecting system may comprise any type of sensors/transmitters, whether optical, electromagnetic or even ultrasonic.

More particularly, the detecting system may take the form, for example, of an optical image-capturing sensor such as a camera. It may be a question of a CCD sensor (CCD standing for charge-coupled device) or of a CMOS sensor comprising a matrix array of miniature photodiodes. The detecting system may, according to another example, take the form of a sensor of infrared radiation such as an infrared camera.

Alternatively, the detecting system may for example take the form of a transceiver of electromagnetic radiation, such as a radar (radar standing for radio detection and ranging), when it is desired to emit and receive radio waves, a lidar (lidar standing for light detection and ranging), when it is desired to use laser-based remote sensing, or an infrared emitter/sensor, when it is desired to emit and receive infrared waves.

The detecting system may for example also take the form of a transceiver of acoustic radiation, when it is desired to emit and receive ultrasonic waves.

The detecting system thus comprises the detecting device, which transmits information on the environment outside the motor vehicle to the acquiring device so that the latter may process this information, it being understood that the acquiring device captures information at the first frequency, and the cleaning device blows the pulsed air onto the glazed area at the second frequency, which is identical +/−10% to the first frequency.

This aforementioned feature is advantageous in that it allows data to be acquired by the acquiring device more reliably. In other words, the information captured by the acquiring device is more reliable when the glazed area is clean or almost clean externally, any dirt having been blown off at a given identical frequency by the cleaning device.

According to one feature of the invention, the first frequency and the second frequency are identical.

According to one feature of the invention, information is acquired by the acquiring device from the detecting device at the same time as pulsed air is blown onto the glazed area by the cleaning device.

According to one alternative of the invention, information is acquired by the acquiring device from the detecting device after pulsed air has been blown onto the glazed area by the cleaning device. In other words, the pulsed air may be blown in synchronization with the acquisition of information, but offset so as be blown chronologically just before this acquiring step.

It will be understood that the simultaneous or offset actions of cleaning the glazed area placed facing the detecting device and of capture of the information by the acquiring device allows information that is reliable in the sense that the glazed area has little or no visually interfering matter on its surface at the moment when the information is read to be obtained. By the feature simultaneous, what is therefore meant is that a time interval close to 0 seconds exists between the time at which information from the detecting device is captured and the time at which pulsed air is blown by the cleaning device. By offset, what is meant is a time interval comprised between 2% and 25% of the length of time between two times of capture of information from the detecting device.

According to one feature of the invention, information is acquired from the detecting device and pulsed air blown onto the glazed area depending on detection of a meteorological event.

The meteorological event may for example be rain and the cleaning device is then able to remove any drops of water that fall on the glazed area of the detecting system.

According to one feature of the invention, the meteorological event is detected by a weather sensor.

The weather sensor may for example be a rain sensor. The rain sensor may then, according to a first example of embodiment of the invention, be independent of the detecting system and be installed in the vicinity of the windshield of the motor vehicle. According to a second example of embodiment of the invention, the rain sensor may also be integrated into the detecting system.

According to one feature of the invention, before pulsed air is blown onto the glazed area by the cleaning device, the method comprises at least one step of detecting the meteorological event by means of the weather sensor.

The weather sensor, the rain sensor for example, transmits data on the meteorological situation outside the motor vehicle to a control unit comprising the acquiring device. The control unit then processes the information sent by the rain sensor and commands, on the one hand, the acquiring device to capture information from the detecting device at the first frequency and, on the other hand, the cleaning device to blow pulsed air onto the glazed area at the second frequency, the latter being equal to the first frequency.

According to one feature of the invention, meteorological-event data collected by the weather sensor comprise at least one datum regarding the intensity of said meteorological event, the first frequency at which information is acquired from the detecting device and the second frequency at which the pulsed air is blown onto the glazed area by the cleaning device being set depending on this datum illustrating the intensity of the meteorological event.

It will be understood from this feature that the first frequency and the second frequency are directly correlated to the intensity of the meteorological event determined by the weather sensor. In other words, the more intense the meteorological event, the higher the first frequency at which information is acquired from the detecting device and the second frequency at which the pulsed air is blown onto the glazed area.

The invention also covers a motor vehicle equipped with a windshield and a system for detecting the environment outside the vehicle, the detecting system comprising a glazed area distinct from the windshield, at least one detecting device and a device for acquiring information from the detecting device, the motor vehicle comprising a cleaning device employing pulsed air directed onto the glazed area of the detecting system, the motor vehicle being configured to implement the cleaning method as defined above.

It will therefore be understood that the rays emitted or received by the detecting system do not pass through the windshield of the motor vehicle, but rather the glazed area of said detecting system.

Such a method for cleaning the detecting system is advantageous, particularly when the motor vehicle is in motion during meteorological events, such as rain for example.

According to one feature of the motor vehicle, the latter comprises a system for wiping the windscreen, the wiping system being operated at a third frequency, the second frequency being identical plus or minus 10% to the third frequency.

The windshield-wiping system comprises at least one wiper blade, an arm bearing the wiper blade and a motor for moving said arm and wiper blade. It will thus be understood that the wiping system and cleaning of the glazed area of the detecting system by the cleaning device are synchronized.

It will also be understood that the first frequency at which information is acquired from the detecting device by the acquiring device is identical to the third frequency at which the wiper blade is moved.

The wiping system may also be controlled by a control unit, the control unit comprising the acquiring device.

The control unit is then connected to the weather sensor. Following reception of the data on the meteorological event, in particular the intensity of the latter, the control unit sends a signal on the one hand to the motor of the wiping system to make it move the wiper blade at the third frequency, and on the other hand to the acquiring device to make it capture information from the detecting device at the first frequency and lastly to the cleaning device to make it blow the flow of pulsed air onto the glazed area of the detecting system at the second frequency, which is identical to the first frequency.

Advantageously, the first frequency, the second frequency and the third frequency are equal to each other and all the actions to which they relate are carried out simultaneously, or offset but at the same frequency.

### BRIEF DESCRIPTION OF DRAWINGS

Other features, details and advantages of the invention will become more clearly apparent, on the one hand, on reading the following description and, on the other hand, from a number of examples of embodiment that are given by way of non-limiting indication, with reference to the appended schematic drawings, in which:

FIG. 1 is a general view of a motor vehicle comprising a windshield equipped with a wiping system and a detecting system that is housed in a grille of the motor vehicle on which is implemented a cleaning method according to the invention;

FIG. 2 is a schematic representation of a detecting-system cleaning device implementing the invention;

FIG. 3 is a set of graphs showing frequencies of use of the detecting system, of the cleaning system and of the wiping system.

### DETAILED DESCRIPTION OF THE INVENTION

Features, variants and various embodiments of the invention may be associated with one another, in various combinations, as long as they are not mutually incompatible or mutually exclusive. It is in particular possible to imagine variants of the invention that comprise only a selection of the features described below, in isolation from the other features described, if this selection of features is sufficient to confer a technical advantage or to differentiate the invention from the prior art.

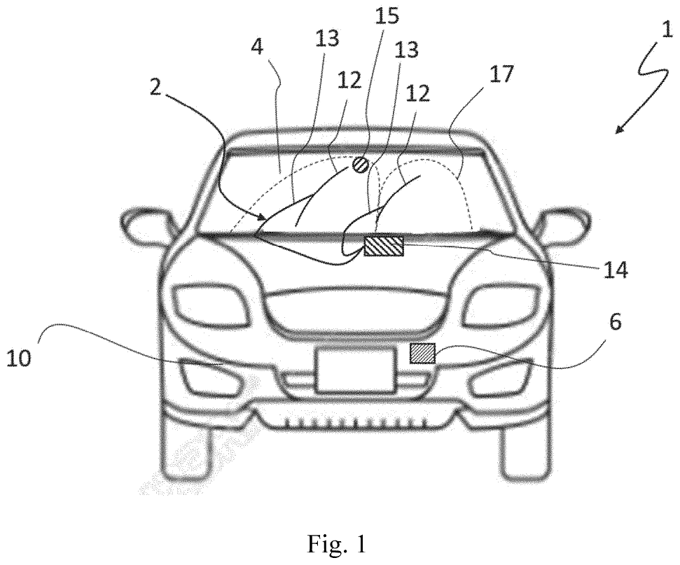

FIG. 1 illustrates a motor vehicle 1 comprising at least a system 2 for wiping a windshield 4 and a system 6 for detecting an environment outside the motor vehicle 1, comprising at least a detecting device 20 and a device 22 for acquiring information from the detecting device 20, and which may especially form part of a driver assistance system of the vehicle 1. By way of non-limiting example, this driver assistance system of the vehicle 1 may consist of adaptive braking systems, systems for keeping the vehicle in a traffic lane, parking assistance systems or even automated or semi-automated driving systems.

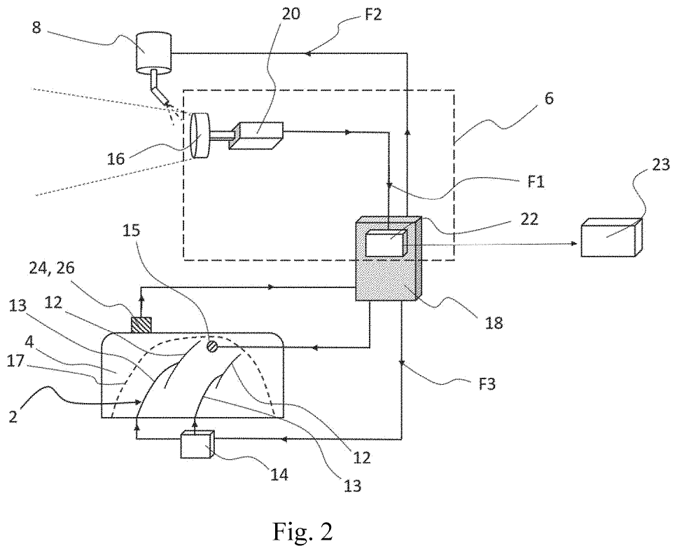

According to one example of embodiment, the detecting system 6 is equipped with a cleaning device 8 (shown in FIG. 2) that allows the detecting system 6 to be kept clean, so that the data acquired and then used are reliable.

In the example illustrated in FIG. 1, the detecting system 6 is placed in a grille 10 of the motor vehicle 1, but it will be understood from what follows that such a detecting system 6 will possibly also or alternatively be positioned at the rear or laterally relative to the motor vehicle 1, or even in a rear-view mirror of this vehicle.

The system 2 for wiping the windshield 4 comprises at least a wiper blade 12, an arm 13 bearing the wiper blade and at least one motor 14 able to drive the wiper blade 12 to move over the windshield 4. In the illustrated example, the wiping system 2 comprises two wiper blades 12 on two arms 13, all thereof being driven to move by the motor 14. Such a movement of the wiper blades 12 over the surface of the windshield 4 allows the latter to be rid of splashes of rain or any other visual disruption. More precisely, the wiping system 2 allows a wiped area 17 of the windshield 4 corresponding to the area of the windshield 4 that is wiped by the wiper blades 12 to be wiped. It is thus possible for a driver of the motor vehicle 1 to have a clear view of the road. Furthermore, in a variant in which the motor vehicle 1 incorporates at least one data-acquiring sensor 15 positioned behind the windshield 4 and in the area 17 wiped by the wiping system 2, said data-acquiring sensor 15 is able to read reliable data, without visual interference.

According to the invention, and in order to make the capture of data by the detecting system 6 more reliable, the cleaning device 8 (shown in FIG. 2) is arranged in such a way that it ensures a glazed area 16 of the detecting system 6 is cleaned.

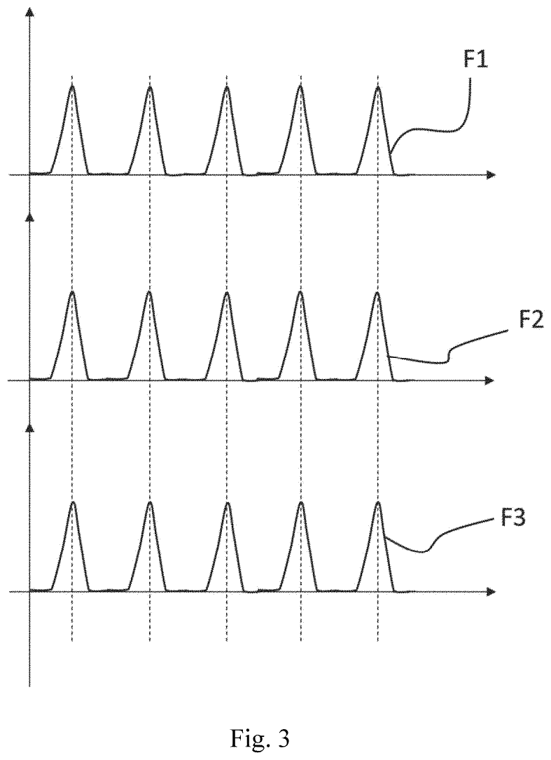

The cleaning device 8, the detecting system 6 and more particularly the method for cleaning the detecting system 6, will now be described in more detail in relation to FIG. 2 and FIG. 3.

FIG. 2 is a schematic representation of the communication and control links between the detecting system 6, the cleaning device 8, the wiping system 2 and a control unit 18.

The detecting system 6 comprises at least the device 22 for acquiring information from the detecting device 20 and the glazed area 16.

The function of the acquiring device 22 is to acquire the information captured by the detecting device 20 and to process it in order to provide, for example, information to an auxiliary device 23 of the motor vehicle. According to a non-limiting example, the acquiring device 22 may process the information in such a way as to deliver an estimation of a distance of the motor vehicle with respect to an obstacle outside said motor vehicle. This distance estimation may subsequently be used by the auxiliary device 23 to deliver information to the driver, in the context of parking assistance, or even be used by the motor vehicle, in the context of adaptive braking systems.

The glazed area 16 is placed facing the detecting device 20, so that the latter may capture information on the environment outside the motor vehicle. The glazed area 16 is then a transparent or translucent area, so as to allow rays emitted and received by the detecting device 20 to pass. The glazed area 16 may for example be glass or Plexiglas. Moreover, the glazed area 16 may advantageously be hydrophobic, either as a result of direct treatment of the material, or as a result of covering with a hydrophobic coating.

The glazed area 16 may be an integral part of the detecting device 20 or an element added to the latter. Advantageously, if the glazed area 16 is not an integral part of the detecting device 20, the glazed area 16 is configured so that its dimensions are identical or substantially identical to the dimensions of the detecting device 20, and for example to the dimensions of the area of the emitting and/or receiving zone of the detecting device 20.

The glazed area 16 of the detecting system 6 is such that it is turned toward the exterior of the motor vehicle 1, and therefore exposed to splashes of water or any other environmental cause of dirtying. A liquid may thus be present on the glazed area 16 and this liquid may correspond to raindrops in the event of bad weather. The quantity of raindrops may thus vary depending on the weather, but they are distributed randomly over the glazed area 16. The function performed by the cleaning device 8 is then to remove these drops from the glazed area 16, in order to prevent them from adversely affecting acquisition of data from the detecting device 20 through the glazed area 16, by the acquiring device 22.

According to the invention, the cleaning device 8 is a pulsed-air cleaning device 8. More precisely, the cleaning device 8 is able to direct, onto the glazed area 16 of the detecting device 20, an air flow that has an air pressure and flow rate adequate and enough to remove the drops of water from said glazed area 16. It should not be thought that the pulsed air flow is limited to removal of drops of water as it may also be used in the case of other soilings, such as dust.

The windshield 4 of the motor vehicle 1 (shown in FIG. 2) comprises the wiping system 8 and a weather sensor 24. The function of the weather sensor 24 is to detect a meteorological event in the environment outside the motor vehicle 1. The weather sensor 24 may then for example be a rain sensor 26 able to detect raindrops striking the windshield 4. It will then be understood that the rain sensor 26 is placed on/in the motor vehicle 1 in such a way as to be able to sense the meteorological phenomenon.

The rain sensor 26 may thus be placed in the vicinity of the windshield 4 of the motor vehicle 1, as shown in FIG. 2, but it may also be integrated into the detecting system 6, according to one example that has not been shown.

The weather sensor 24 may also be configured to collect at least one piece of information on the meteorological event, such as for example an intensity of said meteorological event. In the present case, the rain sensor 26 is able to collect information on rain by means of its contact area, which allows an intensity of the rain to be estimated. The rain sensor 26 should be considered to be able to collect any type of information correlated with the meteorological event, but only the use of intensity will be described here.

Following detection of the meteorological event by the weather sensor 24, the latter transmits at least one piece of information related to said meteorological event to the control unit 18, and in particular the intensity of this meteorological event.

The function of the control unit 18 is to control the wiping system 2 and the detecting system 6, and also to implement the cleaning method. More precisely, the control unit 18 communicates on the one hand with the motor 14 of the wiping system 2, on the other hand with the acquiring device 22 of the detecting system 6 and with the device 8 for cleaning the glazed area 16 of the detecting device 20, and lastly, optionally, with the data-acquiring sensor 15 placed behind the windshield 4 and the observation area of which is wiped, i.e. cleaned, by the system 2 for wiping the windshield 4 of the motor vehicle.

The cleaning method according to the invention begins when a meteorological phenomenon, here rain, occurs in the environment outside the motor vehicle, and the rain sensor 26 detects raindrops striking the windshield 4 of the motor vehicle. The rain sensor 26 then collects information on this meteorological event, and in particular on its intensity, the latter being representative of the heaviness of the rain falling outside the motor vehicle. It will be understood that this intensity of the rain is not set and that it increases or decreases as the weather changes. The rain sensor 26 then continuously captures the intensity of the rain in order to transmit information characterizing a meteorological state to the control unit 18 in real time.

The control unit 18 then processes the intensity datum in order to deduce therefrom a frequency of action of the cleaning device 8, of the wiping system 2 and of the device 22 for acquiring information from the detecting device 20. More precisely, the control unit 18 sets a beating third frequency F3 of the arms 13 of the wiper blades 12 depending on this rain intensity captured by the rain sensor 26. It will be understood that the third frequency F3 at which the arms 13 of the wiper blades 12 are moved is determined by the control unit 18 such that a driver of the motor vehicle may obtain a reliable view of a road on which he is driving. Subsequently, the control unit 18 requires the acquiring device 22 to capture information from the detecting device 20 at a first frequency F1 that is identical to the beating third frequency F3 of the arms 13 of the wiper blades 12. Lastly, the control unit 18 commands the cleaning device 8 to blow pulsed air against the glazed area 16 of the detecting device 20 at a second frequency F2 that is identical plus or minus 5% to the first frequency F1 at which information is captured from the detecting device 20 by the acquiring device 22.

Optionally, the data-acquiring sensor 15 captures a datum from outside the motor vehicle in synchronization with the beating third frequency F3 of the arms 13 of the wiper blades 12. It will be understood that such a feature allows the data-acquiring sensor 15 to capture a reliable datum, the latter being read after the wiped area 17 has been wiped by the wiper blades 12.

The first frequency F1, the second frequency F2 and the third frequency F3 are shown in FIG. 3 in three graphs representative of each of the frequencies and in which the x-axes correspond to time and the y-axes to an action of the acquiring device or of the cleaning device or of the wiping system.

According to one feature of the invention, the first frequency F1 at which data are acquired from the detecting device 20 by the acquiring device 22 and the second frequency F2 at which pulsed air is blown by the cleaning device 8 in the direction of the glazed area 16 of the detecting device 20 are identical.

Advantageously, information is acquired from the detecting device 20 by the acquiring device 22 at the same time as pulsed air is blown onto the glazed area 16 or alternatively acquisition is offset, i.e. occurs chronologically just after the pulsed air is blown. These features are advantageous in that the reliability with which information is acquired by the acquiring device 22 is increased by the absence of visual disruptions in the glazed area 16 of the detecting device 20, as a result of the flow of pulsed air simultaneously blown onto the glazed area 16 by the cleaning device 8. It is also advantageous that the invention uses computing means that have already been developed and validated by the manufacturer of the motor vehicle equipped with the invention, this avoiding new development and limits the costs associated with the invention.

Furthermore, and as also shown in FIG. 3, the aforementioned second frequency F2 is identical plus or minus 10% to the third frequency F3 of movement of the wiping system 2, and more particularly of the wiper blades 12 driven to rotate by the motor 14 of said wiping system 2.

It will thus be understood that a detecting-system cleaning method such as just described is advantageous in that it does not require a new control unit for it to work or the implementation of a new system for computing a frequency from an intensity. The method may therefore be implemented in a motor vehicle already comprising means for computing how the acquiring system should operate.

The invention clearly achieves the set aim by ensuring, via simple to implement means, that the glazed area of a detecting system is cleaned optimally and that the information acquired by the detecting device, then processed by the acquiring device, is reliable.

However, the invention is not limited solely to the means and configurations described and illustrated; it is also applicable to any equivalent means or configurations, and to any combination of such means or configurations.

What is claimed is:

1. A method for cleaning a detecting system on a vehicle, the vehicle including the detecting system including a glazed area, at least one detecting device and a device for acquiring information from the detecting device, and a cleaning device employing pulsed air directed onto the glazed area, the method comprising:
capturing, by the acquiring device, information from the detecting device at a given first frequency; and
blowing, by the cleaning device, the pulsed air onto the glazed area at a second frequency identical to the first frequency, plus or minus 10%.

2. The cleaning method as claimed in claim 1, wherein the first frequency and the second frequency are identical.

3. The cleaning method as claimed in claim 1, wherein information is acquired by the acquiring device from the detecting device at the same time as pulsed air is blown onto the glazed area by the cleaning device.

4. The cleaning method as claimed in claim 1, wherein information is acquired by the acquiring device from the detecting device after pulsed air has been blown onto the glazed area by the cleaning device.

5. The cleaning method as claimed in claim 1, wherein information is acquired from the detecting device and pulsed air blown onto the glazed area depending on detection of a meteorological event.

6. The cleaning method as claimed in claim 5, wherein the meteorological event is detected by a weather sensor.

7. The cleaning method as claimed in claim 6, Further comprises detecting the meteorological event by means of the weather sensor.

8. The cleaning method as claimed in claim 7, wherein meteorological-event data collected by the weather sensor includes at least one datum regarding the intensity of the meteorological event, which controls the first frequency at which information is acquired from the detecting device and the second frequency at which the pulsed air is blown onto the glazed area by the cleaning device.

9. A motor vehicle equipped with a windshield and a detecting system for detecting the environment outside the vehicle, the detecting system including a glazed area distinct from the windshield, at least one detecting device and a device for acquiring information from the detecting device, and a cleaning device employing pulsed air directed onto the glazed area of the detecting system, the motor vehicle being configured to:
capture, by the acquiring device, information from the detecting device at a given first frequency; and
blow, by the cleaning device, the pulsed air onto the glazed area at a second frequency identical to the first frequency, plus or minus 10%.

10. The motor vehicle as claimed in claim 9, further comprises a wiping system for wiping the windshield, the wiping system being operated at a third frequency, with the second frequency being identical plus or minus 10% to the third frequency.
